(19) United States
(12) Patent Application Publication
(10) Pub. No.: US 2021/0142045 A1
(43) Pub. Date: May 13, 2021

(54) Method Of And System For Recognising A Human Face

(71) Applicant: The Face Recognition Company Ltd, Gloucestershire (GB)

(72) Inventors: Tim Noest, Gloucestershire (GB); Nicholas Pears, York Yorkshire (GB)

(21) Appl. No.: 17/252,339

(22) PCT Filed: Jun. 17, 2019
(86) PCT No.: PCT/GB2019/051680

§ 371 Date: Dec. 15, 2020

(30) Foreign Application Priority Data
Jun. 15, 2018 (GB) 1809857.4

(51) Int. Cl. G06K 9/00; G06K 9/62; G06K 9/20; H04N 13/243; H04N 13/282

(52) U.S. Cl. CPC G06K 9/00288; G06K 9/6253; G06K 9/6263; H04N 13/282; H04N 13/243; G06K 9/00268; G06K 9/00201; G06K 9/209

(57) ABSTRACT

Images A of faces at a first location are captured and compared with images B of known subjects . A match result is output when one of the captured images A matches one of the images B of the known subjects. The match result , comprising matching images A,B as captured and known, is transmitted to a second location that is remote from the first . The matching images A,B are displayed at the second location , where a visual comparison of the displayed matching images A,B is carried out by a human viewer. A manual confirmation of matching is provided when the human viewer decides that the displayed matching images A,B are a true match. The result of the manual confirmation is transmitted to a third location that is remote from the second location . Thus, positive recognition results can be provided with a higher degree of certainty, as a result of interaction of both machine and human recognition.

### CROSS-REFERENCE TO RELATED APPLICATIONS

This is the US national stage application of International Application No. PCT/GB2019/051680, filed Jun. 17, 2019, which claims the benefit of priority from GB Application No. 1809857.4, filed Jun. 15, 2018. The entire contents of these prior applications are incorporated by reference.

### FIELD

The present invention relates to the recognition of human faces or parts thereof.

### BACKGROUND

In this specification, a ‘2D camera’ is a camera that produces a 2D image and a ‘3D camera’ is a camera (or camera system) that produces a 3D image.

The generation of 3D images by combining images from 2D cameras is well known. Recognising a human face from a cooperative subject facing in a given direction can readily be achieved—as may happen in a security situation where the subject wishes to gain access. However, recognising a human face from a subject that is not primed to cooperate can be much more difficult.

CN104573637 discloses a multi-camera-based vehicle license plate recognition method. Multiple cameras take images of the license plates of vehicles, e.g. where the vehicles are travelling side-by-side in multiple lanes. The images are compared to arrive at a best recognition result. This is essentially a 2D image process. License plates are generally flat and any image of them that is taken off-axis can readily be processed to give an on-axis view to improve recognition. However, recognising 3D objects such as a human face is much more challenging. When taken off-axis, one part of the face (e.g. the nose) can occlude another part. With images of a human face taken from different viewpoints, it is not possible to mathematically map one view to another, whereas this can be done with anything completely flat, such as a license plate.

Whilst facial recognition methods and systems can be reliable, there often remains a risk of false alerts that can be, at the least, embarrassing or, in other circumstances, prejudicial to security or surveillance operations.

### BRIEF SUMMARY

Preferred embodiments of the present invention aim to provide improved methods and systems for recognising human faces or parts thereof.

According to one aspect of the present invention, there is provided a method of recognising a human face, comprising the steps of:

capturing images of faces at a first location;

comparing the captured images with images of known subjects;

outputting a match result when one of the captured images matches one of the images of the known subjects;

transmitting a match result, comprising matching images as captured and known, to a second location that is remote from the first;

displaying the matching images at the second location;

carrying out, at the second location, a visual comparison of the displayed matching images, by a human viewer;

providing a manual confirmation of matching, when the human viewer decides that the displayed matching images are a true match; and

transmitting the result of the manual confirmation to a third location that is reMote from said second location.

Preferably, said match result is output when one of the captured images matches one of the images of the known subjects with a degree of matching that is above a predetermined threshold.

The first location and the third location may be the same location.

Preferably, said manual confirmation of matching is effected by the human viewer activating a key or device to indicate a true match.

A method as above may further comprise the step of displaying the result of the manual confirmation at said third location, the displayed result indicating by text and/or graphically that the match has been confirmed.

Preferably, said displayed result includes the matching captured and known images.

Preferably, said displayed result includes text to indicate details of the subject of the confirmed match.

At least some of said known images may be stored at said second location and, for such images, the match result received from the first location includes identifying data to identify the matched stored image, which is then displayed at said second location, along with the matched captured image.

At the second location, the human viewer may have a key or device to indicate a false match and, upon activation of that key or device, the result of the manual confirmation is a negative result, indicating that the viewer does not consider that the displayed matching images are a true match.

At the second location, the human viewer may have a key or device to indicate on a predetermined scale the confidence of the viewer that the displayed matching images are a true match.

There may be a plurality of second locations, each of which receives the same match result from the first location, and at each of which a human viewer may provide a manual confirmation of the match as aforesaid.

The manual confirmations from a plurality of second locations for a given match result may be aggregated at the third location.

A data store at the third location may store rating data for a plurality of human viewers and the rating data for a given one of the viewers is applied to each manual confirmation received from that viewer, such that the manual confirmation is weighted by the rating data.

Preferably, the or each human viewer is a ‘Super Recogniser’.

A method as above may comprise the further steps of displaying images of known matches to a human viewer and rating the human viewer in dependence upon the viewer's accuracy in confirming the known matches.

Such known matches may be displayed to a human viewer before and after unconfirmed matches.

Said match result may be output automatically and aggregated with the result of the manual confirmation from at least one said second location.

The invention extends to a system for recognising a human face, the system comprising an imaging device arranged to capture images of faces at a first location; a comparator arranged to compare the captured images with images of known subjects; an output means arranged to output a match result when one of the captured images matches one of the images of the known subjects; a transmitter arranged to transmit a match result, comprising matching images as captured and known, to a second location that is remote from the first; a display arranged to display the matching images at the second location; an input means at the second location arranged to receive an input from a human viewer of the display, to indicate a manual confirmation of matching, when the human viewer decides that the displayed matching images are a true match; and a transmitter at the second location arranged to transmit the result of the manual confirmation to a third location that is remote from said second location: the system being configured to perform a method according to any of the preceding aspects of the invention.

In a method according any of the preceding aspects of the invention, said steps of capturing images, comparing the captured images and outputting a match result may be effected by:

providing an array of cameras that are spaced horizontally from one another such that the cameras provide multiple viewpoints of the scene with overlapping fields of view;

for each of the cameras, generating a sequence of images of the object, normalising each of those images to a canonical view, selecting one or more best normalised image for that camera and passing the or each selected image to a feature extraction processor;

by means of the feature extraction processor, extracting feature data from each of the selected images;

by means of a recognition processor, comparing the extracted feature data of each of the selected images with stored, corresponding feature data of known 3D objects; and

outputting a recognition result when the extracted feature data of at least one of the selected images corresponds to stored, corresponding feature data of at least one of the known 3D objects.

Preferably, an image is passed to the feature extraction processor only if that image is better than a predetermined threshold.

A method as above may comprise the further step of receiving all selected images from all of the cameras and carrying out a further selection from those images to select one or more best normalised image that is passed to the feature extraction processor.

The cameras may be disposed at one side of the scene or surround the scene.

Preferably, the cameras are arranged in an arc as seen in plan view.

Preferably, the scene has a floor and the camera apertures are located at a height above the floor that is in the range 1.5 to 2.5 metres or 3 to 4 metres.

Preferably, the scene has a floor and the camera apertures are located at a height above the floor that is less than 5 metres.

Preferably, the maximum distance between any two cameras of the array is at least 2 metres.

Preferably, the array of cameras comprises at least three, four or five cameras.

Preferably, the scene is at a location where people travel in a common direction.

Preferably, said canonical view is a frontal view.

Preferably, the cameras are 2D cameras.

The step of normalising images to a canonical view may comprise synthesising a canonical viewpoint image from images of different viewpoints from different ones of the cameras.

A system for use in a method as above may include the array of cameras that are spaced from one another such that the cameras provide multiple viewpoints of the scene with overlapping fields of view; for each of the cameras, means for generating a sequence of images of the object, normalising each of those images to a canonical view and selecting at least one best normalised image for that camera; the feature extraction processor; the recognition processor; a data store that stores said corresponding feature data of known 3D objects; and an output device to output said recognition result: the system being configured to perform a method according to any of the respective aspects of the invention.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 shows in plan view part of a system for recognising 3D objects, comprising an array of 2D cameras with overlapping fields of view;

FIG. 2 shows one of the 2D cameras of FIG. 1 in side elevation, mounted above a human subject;

FIG. 3 is a block diagram of the 3D object recognition system;

FIG. 4 is a block diagram to illustrate a method of and system for recognising a human face;

FIG. 5 is a block diagram to illustrate multiple verification options; and

FIG. 6 is a flow chart to indicate steps in confirming and displaying identity.

In the figures, like references denote like or corresponding parts.

### DETAILED DESCRIPTION OF EXAMPLE EMBODIMENTS

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

Referring firstly to FIG. 4, recognition of a human face A takes place in three Phases I, II and III, at respective locations 50, 60 and 70. In Phase I, a face recognition system captures images of faces A at 51 and, at 52, processes the image data and compares it with image data of known subjects. At 53, a match result is output when one of the processed images A matches one of the images B of the known subjects.

For the purposes of this explanation, the exact mode of operation of the face recognition system does not have to be considered in detail. It is sufficient that the system scans faces and outputs a match result when it finds a match. Preferably, the system does this either fully or mostly automatically.

When the face recognition system outputs a match result at 53, it then transmits the match result at 54 from location 50 to location 60, which is remote from location 50. The match result is received at 61 and includes the processed image A and corresponding known image B. At 62, both images A and B are displayed such that they may be viewed and reviewed by a human viewer. At 63, the human viewer makes a visual comparison of the images A and B. At 64, the human viewer provides a manual confirmation of matching, when the viewer decides that the displayed matching images A and B are a true match.

At 65, the result of the manual confirmation 64 is transmitted to the location 70. At 71, the manual confirmation is received and, for example, passed on to a security guard 19, who may receive the manual confirmation on a mobile phone or other device. Preferably, the phone or device displays at least image A. This enables the security guard 19 to either apprehend or monitor the subject 72 of image A.

In this way, personnel such as the security guard 19 may be alerted to the presence of a known subject only after a fully or partly automatic face recognition step (50) has been combined with a human visual and manual confirmation or verification (60). This minimises the risk of false alerts that can be, at the least, embarrassing or, in other circumstances, prejudicial to security or surveillance operations.

Transmission and reception of data may be effected in any practical way. In many cases, wireless communication may be a preferred option. However, at least part of the communication may be hardwired. It is to be noted that, whilst location 60 is usually remote from locations 50 and 70, the two locations 50 and 70 may be coincident. In many cases, the source location (50) of the initial face recognition is likely to be the same location (70) for receiving the manual confirmation. The security guard 19 or other operative is then likely to be in a suitable physical position to locate the subject 72 of a matching and confirmed scan. However, locations 50 and 70 need not be coincident. For example, location 50 may be at a gateway where it is desired to scan passing people and location 70 may be at a surveillance centre at which it is desired to note persons of interest passing through the gateway. There may be more than one location 70 that receives a manual confirmation of a match result. For example, in addition to transmitting a match confirmation to security personnel in or around the location of the face recognition system (50), that confirmation may also be transmitted to a remote security or surveillance centre.

The degree of remoteness of location 60 from locations 50 and 70 may be variable. Typically, the locations will be in different buildings that are many miles apart and they could be anywhere in the world with adequate communications facilities. However, the locations are not necessarily many miles apart and may be remote in the sense of being in different buildings in the same geographical area or different rooms or areas in the same building.

To reduce the transmission of data, image data corresponding to at least some of the known images may be stored or made available at the location 60, as well as being stored or available at location 50. Thus, at 54, instead of transmitting complete image data B, identifying data to identify the image B is transmitted to location 60, which is then able to retrieve the corresponding image B and display it at 62.

When the human viewer makes a manual confirmation at 64, there may be just a single option to confirm—that is, only a Y (Yes) option. If the viewer confirms the match, the viewer then activates a key (e.g. a dedicated physical key, button, etc) or device (e.g. an electronic device) to indicate a Y result. Alternatively, there may be a further option for the human viewer to indicate disagreement with the match—i.e. that the match is false. The viewer then activates a key or device to indicate a N (No) result, which is transmitted at 65.

There may be numerous locations 60, where different human viewers may confirm match results from the face recognition system at location 50. FIG. 5 illustrates such a situation, where the locations 50, 70 are coincident and a match result is indicated in a simple manner at 73. The match result is transmitted to all of the locations 60. When a manual confirmation is received at location 50, 70 from at least one of the locations 60, display 74 is activated to indicate that identity has been confirmed. Optionally, display 74 may include further textual or graphical information, such as name of the identified person, date of birth, any criminal record, etc. When no manual confirmation is received at location 50, 70 from any of the locations 60, display 75 may indicate that identity is as yet unconfirmed. Should any of the human viewers find a false match, display 75 may additionally or alternatively indicate that identity is disputed, or an indication along those lines.

Where numerous human viewers are engaged at respective locations 60, weighting of their responses may be applied, in accordance with rating data for each of the viewers. The rating data will typically be determined by past success rates, such that data from more accurate recognisers is given more credibility than 2 0 data from less accurate recognisers. An example of the way in which this may operate is illustrated in FIG. 6, which indicates steps carried out at location 70.

At 81, a response is received from a Phase II viewer at a location 60. At 82, the Phase II viewer is identified. At 83, the response from the viewer is weighted in accordance with the viewer's rating data. At 84, in the event of a 2 5 positive manual confirmation (True), a tally of positive responses is incremented accordingly. Should the manual confirmation be negative (False), a tally of negative responses is incremented accordingly at 85.

At 86, the result of the aggregation of responses from the various human viewers is displayed. At 87, the display may indicate images A and B with a message that the identity is confirmed. 88 illustrates a similar message, but accompanied by an indication of the confidence in the result—in this example, 93%. The confidence score may be calculated from the aggregate of the manual confirmation responses received, weighted in accordance with the viewers' rating data. It may be expressed as a percentage or on any other suitable scale. If the confidence score is below a threshold, identity is not confirmed. Aggregating results from a plurality of human viewers and/or weighting such results is optional.

Optionally, along with a manual confirmation, a human viewer may be provided with a key or device to indicate on a predetermined scale the confidence of the viewer that the displayed matching images are a true match. This indication of confidence may be incorporated into a final confidence figure, such as that indicated at 88.

One way of indicating confidence without introducing significant delay is to provide the human viewer with a small number of selectable options—for example:

Confident Match

Probable Match

Probable Mis-Match

Confident Mis-Match.

The performance of human viewers may be rated by experimental evaluations of known matches. For example, a human viewer is provided with a series of proposed matches that are known to the system and indicates whether the viewer considers them to be matches. This can give a reasonable accuracy rating to the performance of the viewer. The human viewer may be aware that this evaluation is being carried out experimentally. Alternatively, known matches can be fed to a human viewer at random intervals amongst a feed of live unconfirmed matches, so that the viewer is unaware whether a particular match is in fact known to the system and used for accuracy rating, or whether it is just another live match to be confirmed. Such accuracy rating may be used to weight responses of human viewers.

A further interesting option is for a machine also to be rated for accuracy in an analogous manner and/or for it to be included in a ‘team’ of recognisers that includes both machines and human viewers (at least one of each). The term ‘machine’ here refers to a system such as is shown in FIG. 3, for example (as described in further detail below)—that is, an automated system that performs recognition without human intervention. Results from both machines and human viewers may be aggregated, optionally weighted by accuracy ratings, to give an overall confirmation (true or false) of identity, optionally with an indication of confidence level.

Apart from accuracy rating, an operator (or a processor) may set a percentage figure (or other scale figure) that indicates the amount contributed by one or more machine to a final output. For example, if the percentage figure is 0%, the machine contribution is zero and the final output is determined entirely by human viewer(s). A machine contribution figure of 30% leaves 70% to be contributed by human viewer(s).

A complex aggregation of human and machine scores (results) may consist of a machine learning algorithm, such as a neural network, that learns to combine human and machine ratings in such a way as to generate an optimised aggregated matching performance.

Human viewers at locations 60 may be continuously engaged in confirming or verifying identities as received from locations 50. Typically, each location 60 will receive a stream of match results from numerous locations 50 and the human viewer at a given location 60 will move on from one match result to another, as may be practical.

A method and system as described above may be used with particular advantage where the or each human viewer is a ‘Super Recogniser’. ‘Super Recogniser’ is a known term for people with very superior face recognition ability. It is estimated that 1-2% of the UK population are Super Recognisers who can remember 80% of faces they have seen. Ordinarily, people can only remember about 20% of faces.

In the context of this specification, a Super Recogniser is a person whose facial recognition ability is at least 2, 3 or 4 times as good as that of an ordinary person.

In the above-described and illustrated methods of and systems for recognising a human face, there may be employed a 3D object recognition method and system as will now be described.

The 3D object recognition system that is illustrated in FIGS. 1 to 3 is intended to recognise human faces at or adjacent an entrance 2 to a building 1. An array of five cameras 11-15 is arranged in an arc such that all of the cameras are directed generally towards the building entrance 2. The cameras 11-15 are suspended from a roof 4 of the building 1, such that their apertures (or lenses) are at a height of about 2.5 m above the level of a floor 3. Thus, all of the cameras 11-15 face generally towards people 5 entering the building 1 and slightly downwardly. If the cameras 11-15 are located above an area of the floor 3 where people 5 would not normally walk, the camera apertures may be at a somewhat lower level—e.g. about 2 m above the level of floor 3. The camera apertures are preferably no higher than 5 m above the level of floor 3. In this example, all cameras 11-15 are at the same height. However, they could be at differing heights, which could be helpful in viewing subjects of different heights and or with various tilts of their faces. The cameras 11-15 may be spaced at least 0.5 m apart from one another, measured horizontally—i.e. the horizontal component of their mutual spacing.

The cameras 11-15 are interconnected by a cable 16 that also connects to a Wi-Fi device 17, which in turn connects wirelessly with a Wi-Fi device 18 of a PC server that is located in the building 1. Thus, all of the cameras 11-15 are operatively connected to the PC server 20. If desired, each of the cameras 11-15 may alternatively have its own independent Wi-Fi device such as 17. The PC server 20 provides processing of images from the cameras 11-15 and may manage data flow through the system.

Each of the cameras 11-15 has a field of view that is indicated by broken lines 10. It will be seen that the fields of view 10 overlap one another to a significant extent. That is, there is sufficient overlap between the fields of view 10 to enable different poses of a person 5 to be captured by the different cameras 11-15. This differs from conventional security camera installations where multiple cameras are aimed at different locations and therefore have fields of view that either don't overlap at all or overlap only slightly, since the objective of such installations is to cover as much floor area as possible.

The total field of view obtained by the sum of the fields of view 10 of the cameras 11-15 may conveniently be referred to as a ‘scene’ that is viewed by the cameras. In this example, the cameras 11-15 are to one side of the scene. Alternatively, cameras may surround a scene—either fully or mostly.

The maximum distance between any two of the cameras 11-15 is the distance between cameras 11 and 15 and that defines to some extent the size of the scene. In this example, that distance is at least 2 m and, in order to provide sufficient overlap of fields without requiring complex cameras, the distance is no more than 10 m. The maximum distance from any one of the cameras 11-15 to the scene may be about 5 m and is preferably no more than 10, 15 or 20 m.

If a person 5 enters the building 1 in approximately the middle of the entrance 2, walking forward and looking ahead, the centre camera 13 will capture an image of the person's face that is substantially a frontal view. This is usually the ideal view to facilitate facial recognition. The leftmost (as seen) camera 11 captures a left side view of the face and the intermediate camera 12 captures a view between frontal and left side, which we conveniently refer to here as a left three-quarter view. (It will be appreciated that a ‘side view’ may not be an exact side view and a ‘three-quarter view’ may not be an exact three-quarter view, depending upon the respective positions of the person 5 with respect to the cameras 11-15.)

The rightmost (as seen) camera 15 captures a right side view of the face and the intermediate camera 14 captures a right three-quarter view. The respective facial views as captured by the cameras 11-15 are illustrated diagrammatically in FIG. 1.

In reality, any person 5 entering the building 1 via the entrance 2 may not be exactly in front of the centre camera 13 and may be neither walking nor looking straight ahead. Indeed, it is quite usual for a person entering a building to look to the left and/or to the right to get their bearings. If a person 5 is looking somewhat to the left upon walking through the entrance 2, then cameras 11 and 12 may capture a view that is more frontal than that captured by the centre camera 13. Likewise, if a person 5 is looking somewhat to the right, cameras 14 and 15 may capture views that are more frontal. Additionally, the gaze and/or direction of movement of any person 5 may vary continuously between straight ahead, left and right after the person has entered the building 1. Thus, the viewpoints of the cameras 11-15 towards any given person 5 may be changing continuously.

Reasons for recognising human faces are many and need not be discussed in detail here. The reason may be benign—for example, a store wishing to recognise a loyal customer. The reason may be quite different—for example, store security personnel recognising known shoplifters—or, in many public places these days, recognising known terrorists or other criminals. In many cases, recognition needs to be swift to be of immediate use.

In the illustrated example, any given person 5 entering the building 1 is unlikely to stay for any significant time near the entrance 2. They might do so for various reasons, but it is more likely that they will wish to make their way to their intended destination. This is particularly the case if the person has unlawful intent. Therefore, if the cameras 11-15 are to be useful in recognising people 5, the system of which they are part must operate quickly.

As mentioned above, if a camera views a human face off-axis—that is, other than a straight frontal view—it is likely that some facial features will obscure others. For example, the left side of the face is likely to obscure the right side of the face. The nose is likely to obscure the opposite side of the face from which it is viewed. This is a direct result of the human face being a three-dimensional object. If it were flat (2D), the features would largely be visible when viewed from any angle and there would be considerable scope for processing an image to correct the view to a frontal one.

Techniques are known (and will be known to the skilled reader) for normalising an off-axis 2D view of a 3D human face to approximate to an on-axis, frontal view, typically using detected landmarks. This is known as pose-normalisation and the normalised view may be referred to as a canonical view. However, in order to be effective, the off-axis view to be normalised must not be too far off axis.

The illustrated system enables multiple views to be captured of any given person 5 and for those views to be compared in order to arrive at one or more view that is best suited to recognition. An example of the way in which this may be achieved is now given, with reference to FIG. 3.

In the interests of clarity, FIG. 3 shows just three cameras 11, 13 and 15. However, any desired number of cameras may be employed, along similar lines.

Camera 11 takes continuous images of its field of view. This may be a sequence of still images or it may be a continuous stream that is divided into still frames. The image or frame rate may be in the range 0.5 to 60 per second and preferably 10 to 30 per second—for example, 10 images or frames per second. Processor 31 processes the image A to detect and track a face in the image, generating data 32 that represents a sequence of images of the face. Each of those images is pose-normalised by processor 33, which processes the image to represent it as closely as possible to a frontal view. (If the view just happens to be a good frontal view, there is little or no pose-normalisation to do.) Processor 34 selects the best pose-normalized images from the sequence—typically, the highest quality images, with sufficiently small pose corrections and with good diversity. If the camera 11 provides no image of a selected face that is sufficiently good to be of further use (i.e. it is not better than a predetermined threshold), then processor 34 provides no output.

Processors 31, 33, 34 along with data store 32 are represented as a first processing unit 30. All or some of this unit 30 may be incorporated within the camera 11. Many modern cameras, even those that are relatively inexpensive, possess at least some of the necessary processing ability. Alternatively or additionally, some or all of the functions of processing unit 30 may be provided by the PC server 20.

Cameras 13 and 15 operate in parallel to camera 11, each with their respective first processing unit 30 that operates in a similar manner, to output image data corresponding to the best pose-normalised images (if any) selected by processors 34.

A processor 41 receives all selected images from all of the processors 34 and makes a further selection from them to select the best quality images. Criteria for selecting the best images may be as described above—for example, the highest quality images, with sufficiently small pose corrections and with good diversity (i.e. different from each other according to various metrics).

For each of the images selected by processor 41, facial features (feature vectors) are extracted by a processor 42 and compared by processor 43 to corresponding feature vectors held in a data store 44 that stores the data of a gallery of known 3D subjects. Extracting feature vectors from a facial image is a technique that will be known to the skilled reader and therefore requires no detailed explanation here.

The vector comparison by the processor 43 leads to a feature match score for each selected input image against each of the gallery 3D subjects. The best score and associated 3D gallery object are displayed as output 46, provided that the score exceeds a predefined sensitivity threshold that is adjustable and is stored in data store 45. More than one associated 3D gallery object may be displayed as output 46, if the feature match scores are sufficiently high and close to one another.

Upon obtaining a match with at least one 3D gallery object, output 46 may provide an alert to a user of the PC server 20 and/or to a relevant person such as, for example, a security guard 19, who may take steps to contact and/or apprehend the subject of the match within the building 1. The alert sent to the security guard 19 (or other person) may include an image as captured by the cameras 11-15 and/or one or more corresponding image from the gallery 44, thus enabling the security guard 19 to make a final manual confirmation of identity. Images as captured by the cameras 11-15 and sent to the security guard 19 (or other person) may comprise not only captured facial images, but images that give a fuller picture of the person of interest—for example, showing at least some of the clothes that the person is wearing, for easier identification of that person within the building 1. Such fuller picture images may be stored in the system for a predetermined time—e.g. by way of images streamed from the cameras 11-15. Thus, a security guard 19 (or other person) may be able to see a plurality of captured images together with a plurality of gallery images.

Processor 41 may optionally be dispensed with such that all images from processors 34 are passed through to processor 42. For example, in diverse viewpoint camera setups, only one viewpoint may be able to generate good canonical pose images and therefore no other selection between cameras is necessary.

Processors 42, 43, data stores 44, 45 and output device 46 may be provided and/or controlled by PC server 20.

Preferably, processors 31 can detect and track multiple faces in the same image stream. It is not necessary for the processors 31 of different cameras 11-15 to communicate with one another. They provide independent streams of data, and data is self-selecting in the sense that the processors 31 can only function correctly for one (or maybe two) of the cameras 11-15 at any given time. Thus, if camera 13 is getting a frontal view of a face, its processor 31 will find the face and track it, whereas camera 15 will get a side view and the detector fails. If the subject then changes head pose gradually from camera 13 to camera 15, then camera 14 will get the frontal view and track, then after that camera 15. It is possible that, if adjacent views are not too dissimilar from each other, two cameras could detect and track simultaneously for a short time, but they will be treated as separate entities, and if they are both good quality they both will be sent to the ‘recogniser’ processor 43. In the recogniser 43, it is obvious when it is seeing two views of the same face, as the detection IDs will end up being substantially the same. The recogniser 43 should identify the same person from gallery 44 for both viewpoint tracks. Captured images from both viewpoint tracks could be sent to the security guard 19 (or other person), or one or more captured image from just one viewpoint track could be sent, particularly if the respective match is somewhat better than the other.

The building entrance 2 is an area through which people 5 travel in a common direction, as they enter the building 1. Thus, it provides a good scene location for viewing by the cameras 11-15. Other good scene locations where people can be expected to travel in a common direction include the tops and bottom of staircases and escalators, corridors, lift (elevator) doors, or doorways generally.

As an alternative (or addition, depending upon circumstances) to simple selection of images from the processors 34, images from two or more of the cameras 11-15 may be combined and processed to synthesise a canonical viewpoint image from the different viewpoints of the respective cameras, such that the reconstructed canonical viewpoint matches the viewpoint of the gallery images. For example, suppose that the face of a subject is pointing towards central camera 13, but is obscured from that camera by another person, and yet the two cameras either side of this, cameras 12 and 14, pick up partial views of the left and right sides of the face. These two partial views can then be processed to reconstruct the canonical (e.g. frontal) view, which is then passed to the recogniser 43 to match against the stored images in the gallery 44, with the same canonical viewpoint. Techniques for synthesising one view from other views are known in the art .

In general, in the present context, a ‘canonical’ view is a standard viewpoint at which the system performs recognition. It is the viewpoint used for images stored in the gallery 44. It is typically the frontal view because there tends to be more discriminative information in that view and security personnel are used to manually checking that view. However, other views or viewpoints are possible.

For example, the police store a side view in mugshots. The illustrated system and methods may be adapted to store and detect multiple canonical views—that is, there may be more than one canonical viewpoint.

The PC server 18 (or other processor) may be arranged or configured to evaluate performance of the cameras 11-15, in the sense of relating quality of images received to environmental variables and/or camera settings. Light meters within the building 1 may indicate light levels at the times that images are captured. A control loop incorporating the PC server 18 or other processor may enable manual or automatic adjustment of camera settings (exposure, illumination, etc) to optimise image quality.

Thus, there may be provided a 3D object recognition system and method that can be implemented relatively cheaply and provide fast recognition of known objects. They are particularly suited to the recognition of 3D human faces. They may be relatively cheap because image capture may be effected by using a plurality of relatively cheap 2D cameras with overlapping fields of view, rather than relying upon an expensive camera with complicated control and image processing. The 2D cameras need not have powered mechanical zoom, pan and/or tilt functions, for example, thereby saving on expense. They may be of fixed focus. They are preferably in fixed physical positions and, for economy, they may be designed not to pan or tilt, other than by manual adjustment at their positions. Using multiple 2D cameras helps to avoid complete occlusion of an object by moving agents such as, for example, people, animals and vehicles. It is to be noted that, whereas it is known to use multiple cameras to form 3D or stereo images, the above-described system and method rely only upon 2D images, the processing of which may be much quicker and cheaper.

Any number of 2D cameras may be provided—provided that there are at least two. Preferably, at least three, four or five 2D cameras are provided. In the illustrated example, cameras 12, 13 and 14 are located between end cameras 11, 15, camera 13 being located substantially centrally between end cameras 11, 15. Although, for ease of illustration, cameras 11-15 are shown as mounted on a common rig, they may be individually mounted at suitable positions within the building 1. They may be at least partly disguised or concealed within furniture, fixtures or other objects within the building, so that they are not readily visible to people 5 within the scene.

By incorporating at least part of the intelligence of the system into the camera units, a first stage of selection may be carried out in each of the cameras 11-15, thus reducing to a manageable rate real-time dataflow into PC server 20 that affords central feature extraction (42) and recognition (43) with reference to gallery subjects (44) and sensitivity threshold (45) to provide output (46). To further manage processing requirements and dataflow, the PC server 20 may apply selection as to which of the data streams from cameras 11-15 are to be used at any given time, or it may just accept all of the images that are passed from the individual processors 34.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of recognising a human face, comprising the steps of:
capturing images of faces at a first location;
comparing the captured images with images of known subjects;
outputting a match result when one of the captured images matches one of the images of the known subjects;
transmitting a match result, comprising matching images as captured and known, to a second location that is remote from the first;
displaying the matching images at the second location;
carrying out, at the second location, a visual comparison of the displayed matching images, by a human viewer;
providing a manual confirmation of matching, when the human viewer decides that the displayed matching images are a true match; and
transmitting the result of the manual confirmation to a third location that is remote from said second location.

2. A method according to claim 1, wherein said match result is output when one of the captured images matches one of the images of the known subjects with a degree of matching that is above a predetermined threshold.

3. A method according to claim 1, wherein the first location and the third location are the same location.

4. A method according to claim 1, wherein said manual confirmation of matching is effected by the human viewer activating a key or device to indicate a true match.

5. A method according to claim 1, further comprising the step of displaying the result of the manual confirmation at said third location, the displayed result indicating by text and/or graphically that the match has been confirmed.

6. A method according to claim 5, wherein said displayed result includes the matching captured and known images.

7. A method according to claim 5, wherein said displayed result includes text to indicate details of the subject of the confirmed match.

8. A method according to claim 1, wherein at least some of said known images are stored at said second location and, for such images, the match result received from the first location includes identifying data to identify the matched stored image, which is then displayed at said second location, along with the matched captured image.

9. A method according to claim 1 wherein, at the second location, the human viewer has a key or device to indicate a false match and, upon activation of that key or device, the result of the manual confirmation is a negative result, indicating that the viewer does not consider that the displayed matching images are a true match.

10. A method according to claim 1 wherein, at the second location, the human viewer has a key or device to indicate on a predetermined scale the confidence of the viewer that the displayed matching images are a true match.

11. A method according to claim 1, wherein there are a plurality of second locations, each of which receives the same match result from the first location, and at each of which a human viewer may provide a manual confirmation of the match as aforesaid.

12. A method according to claim 11, wherein the manual confirmations from a plurality of second locations for a given match result are aggregated at the third location.

13. A method according to claim 1, wherein a data store at the third location stores rating data for a plurality of human viewers and the rating data for a given one of the viewers is applied to each manual confirmation received from that viewer, such that the manual confirmation is weighted by the rating data.

14. A method according to claim 1, wherein the or each human viewer is a ‘Super Recogniser’.

15. A method according claim 1, comprising the further steps of displaying images of known matches to a human viewer and rating the human viewer in dependence upon the viewer's accuracy in confirming the known matches.

16. A method according to claim 15, wherein known matches are displayed to a human viewer before and after unconfirmed matches.

17. A method according to claim 1, wherein said match result is output automatically and aggregated with the result of the manual confirmation from at least one said second location.

18. A system for recognising a human face, the system comprising an imaging device arranged to capture images of faces at a first location; a comparator arranged to compare the captured images with images of known subjects; an output means arranged to output a match result when one of the captured images matches one of the images of the known subjects; a transmitter arranged to transmit a match result, comprising matching images as captured and known, to a second location that is remote from the first; a display arranged to display the matching images at the second location; an input means at the second location arranged to receive an input from a human viewer of the display, to indicate a manual confirmation of matching, when the human viewer decides that the displayed matching images are a true match; and a transmitter at the second location arranged to transmit the result of the manual confirmation to a third location that is remote from said second location: the system being configured to perform a method according to claim 1.

19. A method according to claim 1, wherein said steps of capturing images, comparing the captured images and outputting a match result are effected by:
providing an array of cameras that are spaced horizontally from one another such that the cameras provide multiple viewpoints of the scene with overlapping fields of view;
for each of the cameras, generating a sequence of images of the object, normalising each of those images to a canonical view, selecting one or more best normalised image for that camera and passing the or each selected image to a feature extraction processor;
extracting feature data from each of the selected images;
comparing the extracted feature data of each of the selected images with stored, corresponding feature data of known 3D objects using a recognition processor; and
outputting a recognition result when the extracted feature data of at least one of the selected images corresponds to stored, corresponding feature data of at least one of the known 3D objects.

20-31. (canceled)

32. A system for use in a method according to claim 19, the system including the array of cameras that are spaced from one another such that the cameras provide multiple viewpoints of the scene with overlapping fields of view; for each of the cameras, means for generating a sequence of images of the object, normalising each of those images to a canonical view and selecting at least one best normalised image for that camera; the feature extraction processor; the recognition processor; a data store that stores said corresponding feature data of known 3D objects; and an output device to output said recognition result: the system being configured to perform a method according to claim 19.

33-34. (canceled)
